(19) United States
(12) Patent Application Publication
(10) Pub. No.: US 2018/0352834 A1
(43) Pub. Date: Dec. 13, 2018

(54) FOOD COMPOSITIONS FOR MAMMALS

(71) Applicant: Hetal SHETH, Santa Clara, CA (US)

(72) Inventor: Hetal SHETH, Santa Clara, CA (US)

(21) Appl. No.: 16/004,286

(22) Filed: Jun. 8, 2018

Related U.S. Application Data
(60) Provisional application No. 62/517,798, filed on Jun. 9, 2017.

(51) Int. Cl. A23K 20/126; A23K 20/158; A23K 20/174; A23K 20/111; A23K 10/30; A23K 50/42

(52) U.S. Cl. CPC A23K 20/126; A23V 2300/31; A23K 20/174; A23K 20/111; A23K 10/30; A23K 50/42; A23V 2002/00; A23V 2200/02; A23V 2200/3204; A23V 2250/1872; A23V 2250/188; A23V 2250/5118; A23V 2250/7042; A23V 2250/705; A23V 2250/7052; A23V 2250/708; A23V 2250/712; A23K 20/158

(57) ABSTRACT

This disclosure relates to food products. In particular this disclosure relates to dog food products. In one embodiment, the food compositions comprise ingredients based on the principles of dosha. In one embodiment, the compositions comprise sprouted ingredients providing higher levels of nutrition and value.

### CROSS-REFERENCE TO RELATED APPLICATION

This application claims benefit under 35 USC § 119(e) to U.S. Provisional Application No. 62/517,798 filed Jun. 9, 2017 and is hereby incorporated by reference in its entirety.

### TECHNICAL FIELD

This disclosure relates to the food industry. In particular this disclosure relates to food products for pets.

### BACKGROUND

Many people value their pets and treat them as members of their family. In 2017, pet owners spent an estimated 70 billion dollars on their pets, with revenue generated from clothes, toys, food, etc. One of the biggest expenditures comes from food. For most pet owners, pet food is a limited choice. Most people will not make their own pet food and instead rely on store bought products. This situation allows for subpar products and limited range of choices for pet owners.

In response there has been a recent trend of artisan pet food made with organic ingredients and not having any preservatives and fillers. These products focus on providing a quality product based on nutrition however there still lacks a focus on special dietary needs of pets. Pet food is commonly categorized by the age of the animal and is rarely designed to treat specific health issues.

Animals, like humans, suffer from health problems through which diet can help, e.g., allergies, gastrointestinal issues etc. There are many methods available for treating animals through food. One method is the practice of Ayurveda.

Ayurveda is a system of medicine with historical roots in the Indian subcontinent. Ayurveda focuses on the physical existence, mental existence, and personality as a unit, with each element being able to influence the others. Ayurveda promotes a balanced diet with sweet, salty, sour, pungent, bitter, and astringent. The practices of Ayurveda can provide pet foods for the unmet needs of animals suffering from health issues without having to resort to expensive, or potentially dangerous, medical treatment.

There exists a need for food compositions based on the practices of Ayurveda. There exists a need for food compositions designed for improving particular aspects of animal health. There exists a need for methods for producing food compositions.

### BRIEF DESCRIPTION OF THE DRAWINGS

FIG. 1 is an illustrative flowchart of making the food compositions disclosed herein.

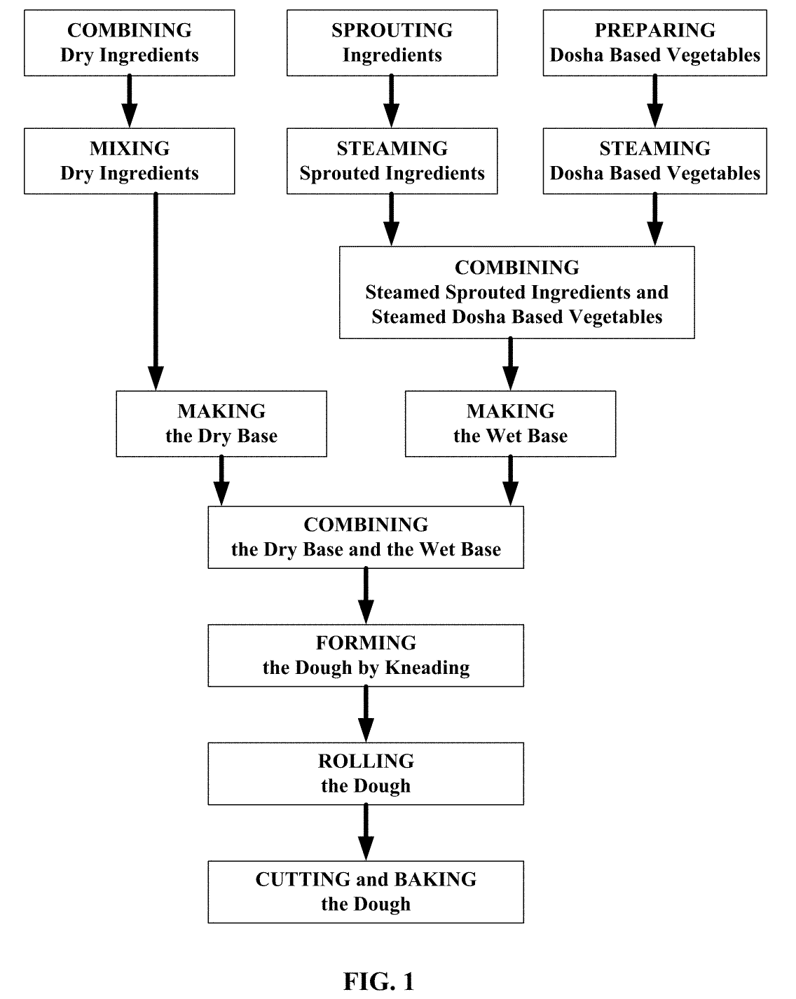

FIG. 2 shows dehulled mung beans.

### DETAILED DESCRIPTION

Disclosed herein are new food compositions designed for improving particular aspects of animal health. In one embodiment, improving particular aspects of comprises alleviating gastrointestinal issues. In one embodiment, improving particular aspects of comprises suppressing allergies. In one embodiment, treating comprises relieving joint issues.

Disclosed herein are new food compositions based on the practices of Ayurveda. In one embodiment, the food compositions comprise sprouted ingredients. In one embodiment, the food compositions comprise curated ingredients.

Disclosed herein are new methods for producing food compositions. In one embodiment, the methods comprise sprouted ingredients. In one embodiment, the methods comprise curated ingredients.

Disclosed herein is a new food composition, comprising:

linoleic acid;

palmitic acid;

p-coumaric acid;

oleic acid;

caffeic acid;

an antioxidant;

a probiotic; and

an ellagitannin.

As used herein, the term “linoleic acid” refers to a compound with the following structural formula:

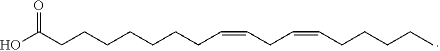 [SMILES: CCCCC/C=C\C/C=C\CCCCCCCC(=O)O]

Linoleic acid is often characterized as a polyunsaturated omega-6 fatty acid. In one embodiment, linoleic acid is derived from moong beans. In one embodiment, linoleic acid is derived from pumpkin. In one embodiment, linoleic acid is derived from pumpkin seeds. In one embodiment, linoleic acid is derived from belleric myrobalan. In one embodiment, linoleic acid is derived from flax seeds. In one embodiment, linoleic acid is derived from neem.

As used herein, the term “derived” refers to obtaining a compound or compounds from a source having the compound or compounds be active. In one embodiment, derived is extracting the oil from a plant. In one embodiment, derived is using a plant in a composition. In one embodiment, derived is extracting a purified compound from a plant.

As used herein, the term “palmitic acid” refers to a compound with the following structural formula:

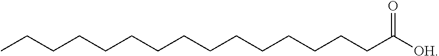 [SMILES: CCCCCCCCCCCCCCCC(=O)O]

Palmitic acid if often characterized as a saturated fatty acid found in animals and plants. In one embodiment, palmitic acid is derived from palm oil. In one embodiment, palmitic acid is derived from moong beans. In one embodiment, palmitic acid is derived from pumpkin. In one embodiment, palmitic acid is derived from pumpkin seeds. In one embodiment, palmitic acid is derived from belleric myrobalan. In one embodiment, palmitic acid is derived from neem.

As used herein, the term “p-coumaric acid” refers to a compound with the following structural formula:

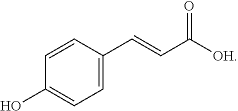 [SMILES: O=C(O)/C=C/c1ccc(O)cc1]

P-coumaric acid is often characterized as a hydroxy derivative of cinnamic acid. There are two isomers in which the hydroxy group is in the meta and ortho position. P-coumaric acid exists as cis and trans isomers.

Within the context of this disclosure, p-coumaric acid may refer to either cis, trans, isomeric form of the molecular formula C₉H₈O₃ or a mixture in any ratio. In one embodiment, p-coumaric acid is derived from moong beans. In one embodiment, p-coumaric acid is derived from pumpkin. In one embodiment, p-coumaric acid is derived from pumpkin seeds. In one embodiment, p-coumaric acid is derived from chebulic myrobalan. In one embodiment, p-coumaric acid is derived from fenugreek.

As used herein, the term “fenugreek” refers to a plant in the family Fabaceae. Fenugreek is often characterized as a common ingredient in Southeast Asia.

As used herein, the term “oleic acid” refers to a compound with the following structural formula:

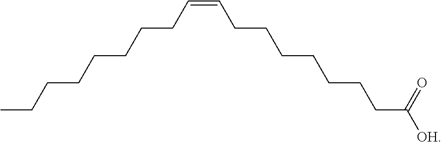 [SMILES: CCCCCCCC/C=C\CCCCCCCC(=O)O]

Oleic acid is often characterized as a fatty acid found in animals and plants. Oleic acid is also known as a monounsaturated omega-9 fatty acid. In one embodiment, oleic acid is derived from moong bean. In one embodiment, oleic acid is derived from pumpkin. In one embodiment, oleic acid is derived from pumpkin seeds. In one embodiment, oleic acid is derived from belleric myrobalan. In one embodiment, oleic acid is derived from neem.

As used herein, the term “belleric myrobalan” refers to Terminalia bellirica, a deciduous tree. Many parts of the tree have historical uses in medicine.

As used herein, the term “neem” refers to Azadirachta indica, which is a tree in the mahogany family Meliaceae. Many parts of the tree have been used in medicine, e.g., the oil, the extract, the leaves, the bark, etc.

As used herein, the term “caffeic acid” refers to a compound with the following structural formula:

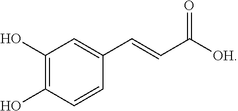 [SMILES: O=C(O)/C=C/c1ccc(O)c(O)c1]

Caffeic acid is often referred to as a hydroxycinnamic acid. Caffeic acid also plays a key role in the production of lignin in plants. In one embodiment, caffeic acid is derived from moong beans. In one embodiment, caffeic acid is derived from pumpkin. In one embodiment, caffeic acid is derived from pumpkin seeds. In one embodiment, caffeic acid is derived from chebulic myrobalan.

As used herein, the term “chebulic myrobalan” refers to Terminalia chebula, which is a species of Terminalia.

As used herein, the term “antioxidant” refers to a substance prohibiting the oxidation of other molecules. Oxidation can cause free radicals, which can cause cell damage in organisms and lead to health problems. In one embodiment, the antioxidant is a natural compound. In one embodiment, the antioxidant is a synthetic compound. In one embodiment, the antioxidant is a Vitamin. In one embodiment, the antioxidant is a food. In one embodiment, the antioxidant is a thiol. In one embodiment, the antioxidant is an acid.

Within the context of this disclosure, the “antioxidant” compound used within the compositions and methods disclosed herein has additional effects on the compositions and methods disclosed herein. As used herein, the term “probiotic” refers to microorganisms associated with promoting good health within an organism. In one embodiment, the probiotic are microorganisms promoting gastral health. In one embodiment, the probiotic is derived from sprouted plants.

Sprouted plants provide additional health benefits versus the non-sprouted plant. Sprouted plants produce more antioxidants, probiotics, fiber, minerals, vitamins, phytochemicals, etc. In one embodiment, the spouted plant is moong beans. In one embodiment, the sprouted plant is lentils. In one embodiment, the sprouted plant is peas.

As used herein, the term “ellagitannin” refers to a class of hydrolyzable tannins, including gallic or ellagic acid. Ellagitannins are often used in the biosynthesis of ellagic acid, then the ellagic acid is used for a number of other biosynthesis processes. In one embodiment, the ellagitannin is derived from amla, also known as Indian Berry. In one embodiment, the ellagitannin is derived from chebulic myrobalan. In one embodiment, the ellagitannin is derived from belleric myrobalan.

In one embodiment, the antioxidant is chosen from Vitamin E, Vitamin C, Vitamin B1, Vitamin B5, or Vitamin B6.

As used herein, the term “Vitamin E” refers to a class of compounds including tocopherols and tocotrienols. In one embodiment, the Vitamin E is alpha tocopherol. In one embodiment, the Vitamin E is beta tocopherol. In one embodiment, the Vitamin E is gamma tocopherol. In one embodiment, the Vitamin E is delta tocopherol. In one embodiment, the Vitamin E is alpha tocotrienol. In one embodiment, the Vitamin E is beta tocotrienol. In one embodiment, the Vitamin E is gamma tocotrienol. In one embodiment, the Vitamin E is delta tocotrienol. In one embodiment, Vitamin E is derived from moong bean. In one embodiment, Vitamin E is derived from pumpkin. In one embodiment, Vitamin E is derived from oats. In one embodiment, Vitamin E is derived from carrots.

As used herein, the term “Vitamin C” refers to ascorbic acid, L-ascorbic acid, or any functionally similar derivative. In one embodiment, Vitamin C is the following compound:

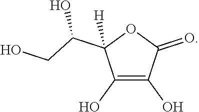 [SMILES: O=C1O[C@H]([C@@H](O)CO)C(O)=C1O]

In one embodiment, Vitamin C is derived from fennel. In one embodiment, Vitamin C is derived from peas. In one embodiment, Vitamin C is derived from carrots. In one embodiment, Vitamin C is derived from ginger.

As used herein, the term “Vitamin B1” refers to a compound with the following structural formula:

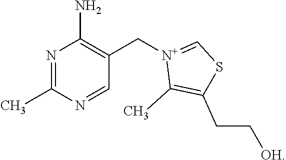 [SMILES: Cc1ncc(C[n+]2csc(CCO)c2C)c(N)n1]

Vitamin B1 is also referred to as thiamine. In one embodiment, Vitamin B1 is derived from carrots. In one embodiment, Vitamin B1 is derived from peas. In one embodiment, Vitamin B1 is derived from flaxseed. In one embodiment, Vitamin B1 is derived from lentils. In one embodiment, Vitamin B1 is derived from sweet potatoes.

As used herein, the term “Vitamin B5” refers to a compound with the following structural formula:

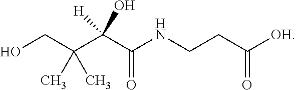

Vitamin B5 is also known as pantothenic acid and is often characterized as part of the synthesis of Coenzyme-A. In one embodiment, Vitamin B5 is derived from carrots. In one embodiment, Vitamin B5 is derived from lentils.

As used herein, the term “Vitamin B6” refers to a group of molecules participating in many important biological functions, e.g., gene expression, hemoglobin synthesis, nervous system maintenance, etc. In one embodiment, Vitamin B6 is pyridoxine. In one embodiment, Vitamin B6 is pyridoxine 5′-phosphate. In one embodiment, Vitamin B6 is pyridoxal. In one embodiment, Vitamin B6 is pyridoxal 5′-phosphate. In one embodiment, Vitamin B6 is pyridoxamine. In one embodiment, Vitamin B6 is pyridoxamine 5′-phosphate. In one embodiment, Vitamin B6 is 4-pyridoxic acid. In one embodiment, Vitamin B6 is pyritinol. In one embodiment, Vitamin B6 is derived from lentils. In one embodiment, Vitamin B6 is derived from carrots. In one embodiment, Vitamin B6 is derived from peas.

In one embodiment, the ellagitannin is chosen from chebulinic acid, chebulic acid, luteic acid, chebulagic acid, emblicanin A, emblicanin B, punigluconin, or pedunculagin.

As used herein, the term “chebulinic acid” refers to a compound with the following structural formula:

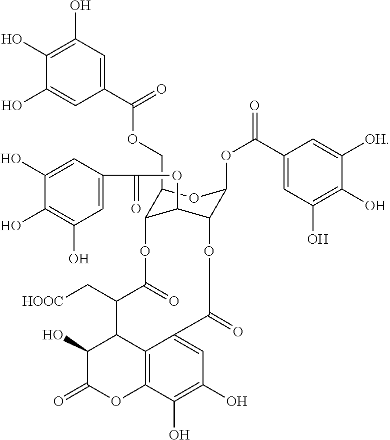 [SMILES: O=C(O)CC1C(=O)OC2C(COC(=O)c3cc(O)c(O)c(O)c3)OC(OC(=O)c3cc(O)c(O)c(O)c3)C(OC(=O)c3cc(O)c(O)c4c3C1[C@H](O)C(=O)O4)C2OC(=O)c1cc(O)c(O)c(O)c1]

Chebulinic acid is often characterized as one of the active components of triphala. In one embodiment, chebulinic acid is derived from chebulic myrobalan. In one embodiment, chebulinic acid is derived from belleric myrobalan.

As used herein, the term “chebulic acid” refers to a compound with the following structural formula:

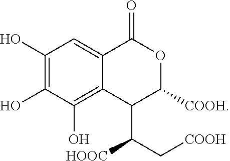 [SMILES: O=C(O)C[C@@H](C(=O)O)C1c2c(cc(O)c(O)c2O)C(=O)O[C@@H]1C(=O)O]

Chebulic acid is often characterized as one of the active components of triphala. In one embodiment, chebulinic acid is derived from chebulic myrobalan. In one embodiment, chebulic acid is derived from belleric myrobalan.

As used herein, the term “luteic acid” refers to a compound with the following structural formula:

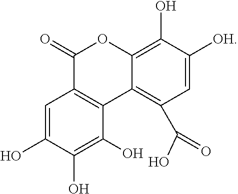 [SMILES: O=C(O)c1cc(O)c(O)c2oc(=O)c3cc(O)c(O)c(O)c3c12]

Luteic acid is often characterized as intermediate in the synthesis of ellagic acid. In one embodiment, luteic acid is derived from chebulic myrobalan. In one embodiment, luteic acid is derived from belleric myrobalan.

As used herein, the term “chebulagic acid” refers to a compound with the following structural formula:

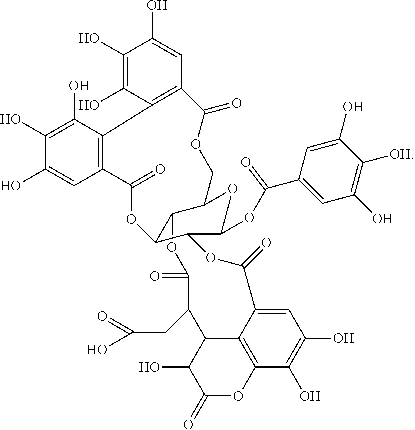 [SMILES: O=C(O)CC1C(=O)OC2C3COC(=O)c4cc(O)c(O)c(O)c4-c4c(cc(O)c(O)c4O)C(=O)OC2C(OC(=O)c2cc(O)c(O)c4c2C1C(O)C(=O)O4)C(OC(=O)c1cc(O)c(O)c(O)c1)O3]

Chebulagic acid is often characterized as an immunosuppressive, hepatoprotective, and a potent alpha-glucosidase inhibitor, a human gut enzyme useful in diabetic studies. In one embodiment, chebulagic acid is derived from chebulic myrobalan. In one embodiment, chebulagic acid is derived from belleric myrobalan. In one embodiment,

As used herein, the term “emblicanin A” refers to a compound with the following structural formula:

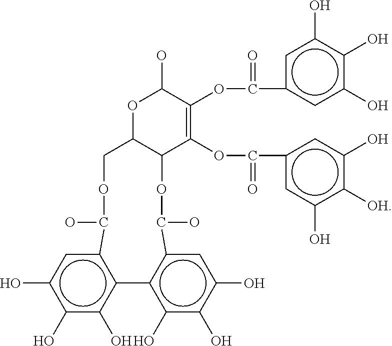

Emblicanin A is often characterized as an antioxidant. In one embodiment, emblicanin A is derived from amla.

As used herein, the term “emblicanin B” refers to a compound with the following structural formula:

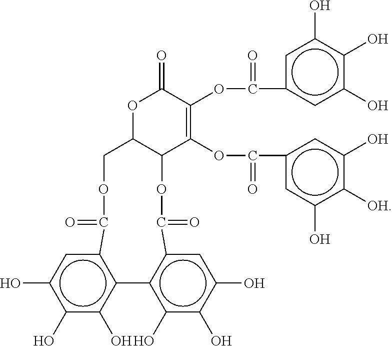

Emblicanin B is often characterized as an antioxidant. In one embodiment, emblicanin B is derived from amla. In one embodiment, emblicanin B is converted from emblicanin A.

As used herein, the term “punigluconin” refers to a compound with the following structural formula:

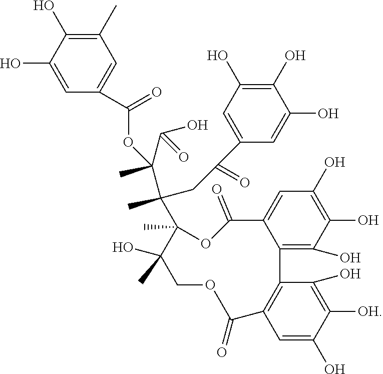 [SMILES: Cc1cc(C(=O)O[C@](C)(C(=O)O)[C@](C)(CC(=O)c2cc(O)c(O)c(O)c2)[C@@]2(C)OC(=O)c3cc(O)c(O)c(O)c3-c3c(cc(O)c(O)c3O)C(=O)OC[C@]2(C)O)cc(O)c1O]

In one embodiment, punigluconin is derived from chebulic myrobalan. In one embodiment, punigluconin is derived from belleric myrbobalan. In one embodiment, punigluconin is derived from pomegranate.

As used herein, the term “pedunculagin” refers to a compound with the following structural formula:

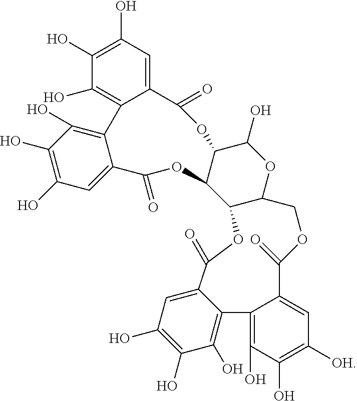 [SMILES: O=C1OCC2OC(O)[C@H]3OC(=O)c4cc(O)c(O)c(O)c4-c4c(cc(O)c(O)c4O)C(=O)O[C@@H]3[C@H]2OC(=O)c2cc(O)c(O)c(O)c2-c2c1cc(O)c(O)c2O]

In one embodiment, pedunculagin is derived from chebulic myrobalan. In one embodiment, pedunculagin is derived from belleric myrobalan. In one embodiment, pedunculagin is derived from pomegranate.

In one embodiment, the food compositions disclosed herein comprise a steroidal lactone chosen from tropine, cuscohygrine, or a withanolide.

As used herein, the term “steroidal lactone” refers to a compound with a steroid backbone attached to a lactone. In one embodiment, the steroidal lactone is derived from ashwagandha. In one embodiment, the steroidal lactone is tropine. In one embodiment, the steroidal lactone is cuscohygrine. In one embodiment, the steroidal lactone is a withanolide.

As used herein, the term “tropine” refers to a compound with the following structural formula:

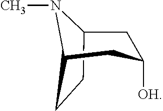

Tropine is also referred to as 3-tropanol. Tropane is also a derivative of tropane. In one embodiment, tropine is derived from ashwagandha.

As used herein, the term “cuscohygrine” refers to a compound with the following structural formula:

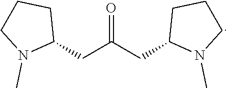 [SMILES: CN1CCC[C@@H]1CC(=O)C[C@@H]1CCCN1C]

Cuscohygrine is often characterized as an alkaloid derived from cocoa. In one embodiment, tropine is derived from ashwagandha.

As used herein, the term “withanolide” refers to a group of naturally occurring steroids built on an ergostane skeleton. As used herein, the term withanolide comprises at least 300 compounds. In one embodiment, withanolide is derived from the nightshade family, e.g., tomatillo. In one embodiment, tropine is derived from ashwagandha. In one embodiment, the withanolide is Withaferin A.

In one embodiment, the food compositions disclosed herein comprise a bacoside.

As used herein, the term “bacoside” refers to a class of compounds isolated from bacopa monnieri. In one embodiment, the bacoside is Bacoside A. In one embodiment, the bacoside is Bacoside A3. In one embodiment, the bacoside is jujubogenin.

In one embodiment, the food compositions disclosed herein comprise trigonelline, cinnamic acid, or scopoletin.

As used herein, the term “trigonelline” refers to a compound with the following structural formula:

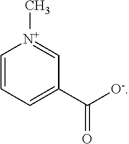

Trigonelline is often characterized as a product of niacin metabolism. In one embodiment, trigonelline is derived from fenugreek. In one embodiment, trigonelline is derived from oats. In one embodiment, trigonelline is derived from arbacia.

As used herein, the term “cinnamic acid” refers to a compound with the following structural formula:

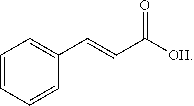 [SMILES: O=C(O)/C=C/c1ccccc1]

Cinnamic acid is often characterized as a flavor component of cinnamon. In one embodiment, cinnamic acid is derived from cinnamon. In one embodiment, cinnamic acid is derived from fenugreek.

As used herein, the term “scopoletin” refers to a compound with the following structural formula:

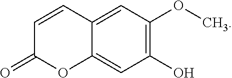 [SMILES: COc1cc2ccc(=O)oc2cc1O]

Scopoletin within the context of this disclosure is a molecule having benefits for regulating blood pressure. In one embodiment, scopoletin is derived from fenugreek. In one embodiment, scopoletin is derived from chicory. In one embodiment, scopoletin is derived from henbane bell. In one embodiment, scopoletin is derived from nettles.

As used herein, the term “henbane bell” refers to a plant belonging to the family Solanaceae.

As used herein, the term “nettles” refers to a perennial flowering plant in the family Urticaceae

In one embodiment, the food compositions disclosed herein comprise nimbin, nimbinin, or nimbidin.

As used herein, the term “nimbin” refers to a compound with the following structural formula:

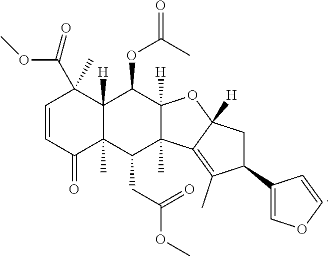 [SMILES: COC(=O)C[C@H]1[C@]2(C)C3=C(C)[C@H](c4ccoc4)C[C@H]3O[C@@H]2[C@H](OC(C)=O)[C@@H]2[C@]1(C)C(=O)C=C[C@@]2(C)C(=O)OC]

Nimbin is often characterized as a major component of neem. In one embodiment, nimbin is derived from neem. In one embodiment, nimbin is derived from the leaves of neem. In one embodiment, nimbin is derived from the bark of neem. In one embodiment, nimbin is derived from the oil of neem.

As used herein, the term “neem” refers to Azadirachta indica, which is a tree in the mahogany family Meliaceae.

As used herein, the term “nimbinin” refers to a compound with the following structural formula:

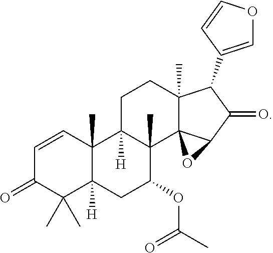

Nimbinin is also known as epoxyazadiradione. Nimbinin is often characterized as an insecticide. In one embodiment, nimbinin is derived from neem. In one embodiment, nimbinin is derived from the leaves of neem. In one embodiment, nimbinin is derived from the bark of neem. In one embodiment, nimbinin is derived from the oil of neem.

As used herein, the term “nimbidin” refers to a compound with the following structural formula:

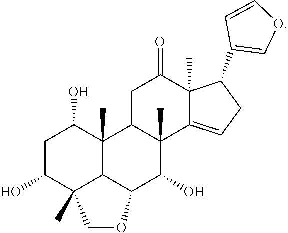

Nimbidin is often characterized as an insecticide. In one embodiment, nimbidin is derived from neem. In one embodiment, nimbidin is derived from the leaves of neem. In one embodiment, nimbidin is derived from the bark of neem. In one embodiment, nimbidin is derived from the oil of neem.

In one embodiment, the food composition disclosed herein comprises curcumin.

As used herein, the term “curcumin” refers to a compound with the below described structural formula, present in either enol form or keto form or a mixture thereof.

The enol form has the following structural formula:

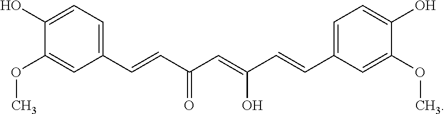 [SMILES: COc1cc(/C=C/C(=O)/C=C(O)/C=C/c2ccc(O)c(OC)c2)ccc1O]

The keto form has the following structural formula:

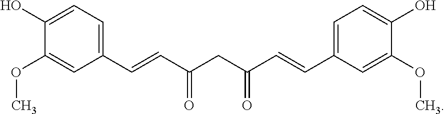 [SMILES: COc1cc(/C=C/C(=O)CC(=O)/C=C/c2ccc(O)c(OC)c2)ccc1O]

Curcumin is often characterized as a complexometric indicator for boron. In one embodiment, curcumin is derived from turmeric. In one embodiment, curcumin is derived from ginger.

In one embodiment, the food compositions disclosed herein are substantially free of soy. In one embodiment, the food compositions disclosed herein are substantially free of corn. In one embodiment, the food compositions disclosed herein are substantially free of wheat. In one embodiment, the food compositions disclosed herein are substantially free of gluten.

Disclosed herein is a method for making a food composition, comprising:

creating a dry base;

pureeing sprouted ingredients and dosha based vegetables into a wet base;

kneading the dry base and the wet base into a dough;

cutting the dough into bars;

flattening the bars into sheets;

heating the sheets; and

cutting the sheets into squares.

As used herein, the term “creating” refers to making, producing, generating, and/or fabricating. In one embodiment, creating comprises making a food base. In one embodiment, creating comprises using machines for cutting and mixing ingredients. In one embodiment, creating comprises selecting specific ingredients for a food composition.

As used herein, the term “dry base” refers to a mixture of ingredients substantially free of water. In one embodiment, the dry base comprises ingredients substantially free of water. In one embodiment, the dry base comprises ingredients with water and the water is removed from the dry base. In one embodiment, the dry base comprises moong beans. In one embodiment, the dry base comprises sprouted lentils. In one embodiment, the dry base comprises oats. In one embodiment, the dry base comprises pumpkins. In one embodiment, the dry base comprises monocalcium phosphate. In one embodiment, the dry base comprises calcium carbonate. In one embodiment, the dry base comprises dried kelp. In one embodiment, the dry base comprises taurine. In one embodiment, the dry base comprises zinc oxide. In one embodiment, the dry base comprises ferrous sulfate. In one embodiment, the dry base comprises D1-alphatocopheryl acetate. In one embodiment, the dry base comprises choline chloride. In one embodiment, the dry base comprises selenium. In one embodiment, the dry base comprises Vitamin B12. In one embodiment, the dry base comprises Vitamin A palmitate. In one embodiment, the dry base comprises ergocalciferol.

In one embodiment, the term “substantially free of water” refers to comprising between 0-10% water.

In one embodiment, the term “substantially free of water” refers to comprising less than 0-5% water.

In one embodiment, the term “substantially free of water” refers to comprising less than 0-1% water.

As used herein, the term “pureeing” refers to steaming, straining, mixing, grinding, processing, cutting, and/or blending ingredients into a relatively smooth mass. In one embodiment, pureeing comprises blending ingredients until a smooth mass is formed. In one embodiment, pureeing comprises heating ingredients and grinding until a relatively smooth mass if formed. In one embodiment, pureeing comprises mixing ingredients into a mass and pushing the mass through a sieve to create a relatively smooth mass.

As used herein, the term “dosha based vegetables” refers to natural ingredients selected for a diet based on the practices of Ayurveda. In one embodiment, the dosha based vegetables are selected on taste, e.g., sweet, sour, salty, pungent, bitter, and astringent. In one embodiment, dosha based vegetables are selected to balance the principle of vata. In one embodiment, dosha based vegetables are selected to balance the principle of pitta. In one embodiment, dosha based vegetables are selected to balance the principle of kapha. In one embodiment, the dosha based vegetables are sprouted.

As used herein, the term “preparing” refers to making ready for use. In one embodiment, preparing comprises cleaning ingredients. In one embodiment, preparing comprises cutting ingredients. In one embodiment, preparing comprises the dosha based vegetables soaked in water. In one embodiment, preparing comprises the dosha based vegetables steamed and brought to ambient temperature. In one embodiment, preparing comprises sprouting ingredients.

As used herein, the term “wet base” refers to a mixture of ingredients comprising water. In one embodiment, the wet base comprises moong bean puree. In one embodiment, the wet base comprises sprouted moong bean puree. In one embodiment, the wet base comprises green and yellow pea puree. In one embodiment, the wet base comprises sprouted green and yellow pea puree. In one embodiment, the wet base comprises chickpea puree. In one embodiment, the wet base comprises sprouted chickpea puree. In one embodiment, the wet base comprises sweet potatoes. In one embodiment, the wet base comprises carrots. In one embodiment, the wet base comprises beets. In one embodiment, the wet base comprises butternut squash. In one embodiment, the wet base comprises water cress. In one embodiment, the wet base comprises pumpkin. In one embodiment, the wet base comprises spinach. In one embodiment, the wet base comprises kale. In one embodiment, the wet base comprises spinach. In one embodiment, the wet base comprises zucchini. In one embodiment, the wet base comprises cilantro. In one embodiment, the wet base comprises broccoli. In one embodiment, the wet base comprises green beans. In one embodiment, the wet base comprises curry leaves. In one embodiment, the wet base comprises sesame paste. In one embodiment, the wet base comprises coconut oil. In one embodiment, the wet base comprises sesame seed paste. In one embodiment, the wet base comprises olive oil.

As used herein, the term “kneading” refers to mixing ingredients for developing strength, cohesion, distribution, etc. In one embodiment, kneading comprises using machines to continuously mix ingredients. In one embodiment, kneading comprises mixing ingredients until a smooth malleable mass is formed. In one embodiment, kneading comprises combining a wet base and dry base into a cohesive mass. In one embodiment, the dough comprises a wet base to dry base ratio of 1:5 to 1:10. In one embodiment, the dough comprises a wet base to dry base ratio of 1:5 to 1:10. In one embodiment, the dough comprises a wet base to dry base ratio of 1:4 to 1:15. In one embodiment, the dough comprises a wet base to dry base ratio of 1:3 to 1:20. In one embodiment, the dough comprises a wet base to dry base ratio of 1:2 to 1:25.

As used herein, the term “dough” refers to a malleable mass. In one embodiment, the dough comprises a wet and dry base mixed to form a single malleable mass. In one embodiment, the dough comprises sprouted ingredients. In one embodiment, the dough is kept at a cool temperature to prevent destroying important nutrients.

As used herein, the term “cutting” refers to slicing, fragmenting, trimming, and/or clipping. In one embodiment, cutting comprises using scissors. In one embodiment, cutting comprises using wires. In one embodiment, cutting comprises using a sharp edge or blade, e.g., a knife.

As used herein, the term “bars” refers to mass in a three-dimensional rectangular shape. In one embodiment, the bars are squares. In one embodiment, the bars are longer in length than in width. Within the context of this disclosure, the dough may also be cut into various shapes, e.g., bones, circles, animals, stars, etc.

As used herein, the term “flattening” refers to applying force or a tool for creating a flat surface. In one embodiment, flattening comprises using a spatula for smoothing the surface of a dough. In one embodiment, flattening comprises using pressure to create an even surface. In one embodiment, the surface comprises holes or cavities but the surface is relatively smooth.

As used herein, the term “sheet” refers to a flat piece of mass. In one embodiment, bars are flattened into sheets. In one embodiment, the sheet is 1 to 30 mm thick. In one embodiment, the sheet is 2 to 25 mm thick. In one embodiment, the sheet is 3 to 20 mm thick. In one embodiment, the sheet is 4 to 15 mm thick. In one embodiment, the sheet is 5 to 10 mm thick.

As used herein, the term “heating” refers to applying energy to raise the temperature. In one embodiment, heating comprises using an oven. In one embodiment, heating comprises using fire. In one embodiment, heating comprises using light. In one embodiment, heating comprises temperatures of 100-600 degrees Fahrenheit. In one embodiment, heating comprises temperatures of 200-500 degrees Fahrenheit. In one embodiment, heating comprises temperatures of 300-400 degrees Fahrenheit.

As used herein, the term “square” refers to a shape comprising four equal sides. In one embodiment, the sheet is cut into squares. In one embodiment, the sheet is cut into circles. In one embodiment, the square is heated. In one embodiment, the circle is heated.

In one embodiment, the methods disclosed herein comprise placing the squares into packaging resisting sunlight, temperatures, and air.

As used herein, the term “packaging” refers to packing or covering a mass with other material, e.g., parchment, foil, plastic, etc. In one embodiment, the packaging comprises plastic. In one embodiment, the packaging comprises foil. In one embodiment, the packaging comprises parchment. In one embodiment, packaging comprises wax paper. In one embodiment, the packaging comprises paper.

As used herein, the term “resisting” refers to preventing, stopping, or slowing down. In one embodiment, resisting comprises preventing air from entering. In one embodiment, resisting comprises stopping light from reaching the surface of a mass. In one embodiment, resisting comprises preventing large temperature changes.

In one embodiment, the methods disclosed herein comprise total dry mass of the squares is equal to total dry mass of the dry base.

In one embodiment, the water content of the squares is between 0-15%.

In one embodiment, the water content of the squares is between 0-10%.

In one embodiment, the water content of the squares is between 0-1%.

In one embodiment, the water content of the squares is between 5-75%.

In one embodiment, the water content of the squares is between 15-60%.

In one embodiment, the water content of the squares is between 25-50%.

In one embodiment, the water content of the squares is between 30-40%.

In one embodiment, the methods disclosed herein comprise vacuum sealing the squares into a bag.

As used herein, the term “vacuum sealing” refers to removing air and preventing air from entering. In one embodiment, vacuum sealing comprises removing air and applying heat to enclose packaging to prevent air from entering. In one embodiment, vacuum sealing comprises using pressure for removing air and heating to seal the packaging. Vacuum sealing allows many food products to have longer shelf life through the removal of air.

As used herein, the term “bag” refers to a non-rigid container with an opening. In one embodiment, the bag closes. In one embodiment, the bag has an opening. In one embodiment, the bag is composed of plastic. In one embodiment, the bag is designed to withstand pressure. In one embodiment, the bag is tinted reflecting sunlight.

Disclosed herein is a method of treating a mammal comprising:

identifying a mammal in need of treatment; and

administering to said mammal a composition comprising,

linoleic acid;

palmitic acid;

p-coumaric acid;

oleic acid;

caffeic acid;

pantothenic acid;

an antioxidant;

a probiotic; and

an ellagitannin.

As used herein, the term “identifying” refers to examining, diagnosing, and/or determining. In one embodiment, identifying comprises examining a mammal's physique. In one embodiment, identifying comprises determining a mammal's eating habits. In one embodiment, identifying comprises diagnosing a mammal's body temperature. In one embodiment, identifying comprises determining a mammal's energy level. In one embodiment, identifying comprises using a computer program for calculating the percentages of compositions for treatment. In one embodiment, identifying comprises customizing a composition for a mammal's need.

As used herein, the term “mammal” refers to an animal with a vertebrate with a neocortex, hair, three middle ear bones, and mammary glands. In one embodiment, the mammal is a dog. In one embodiment, the mammal is a cat. In one embodiment, the mammal is a horse. In one embodiment, the mammal is a pig.

As used herein, the term “treatment” refers to care, remedy, cure, etc., of a condition. In one embodiment, the treatment is the food compositions disclosed herein. In one embodiment, the treat varies based on the needs of a mammal. In one embodiment, the treatment is for allergies. In one embodiment, the treatment is for gastrointestinal issues.

As used herein, the term “administering” refers to applying. In one embodiment, administering comprises feeding a mammal with the food compositions disclosed herein. In one embodiment, administering is determining the need of a mammal and feeding a specific food composition. In one embodiment, administering comprises periodically diagnosing a mammal and applying the proper food compositions based on the needs of the mammal.

In one embodiment, the antioxidant is chosen from Vitamin E, Vitamin C, Vitamin B1, Vitamin B5, or Vitamin B6.

In one embodiment, the ellagitannin is chosen from chebulinic acid, chebulic acid, luteic acid, chebulagic acid, emblicanin A, emblicanin B, punigluconin, or pedunculagin.

In one embodiment, the methods disclosed herein comprise a steroidal lactone chosen from tropine, cuscohygrine, or a withanolide.

In one embodiment, the methods disclosed herein comprise a bacoside.

In one embodiment, the methods disclosed herein comprise trigonelline, cinnamic acid, or scopoletin.

In one embodiment, the methods disclosed herein comprise nimbin, nimbinin, or nimbidin.

In one embodiment, the methods disclosed herein comprise treating teeth or gums. In one embodiment, the teeth or gums belong to a mammal. In one embodiment, the teeth or gums belong to a dog. In one embodiment, the teeth or gums belong to a cat.

As used herein, the term “treating” refers to responding to a condition. In one embodiment, treating comprises feeding a mammal the food compositions disclosed herein for dietary reasons. In one embodiment, treating comprises feeding a mammal the food compositions disclosed herein for dental issues.

Disclosed herein is a tooth powder composition, comprising:

nimbin;

nimbinin;

nimbidin;

trans-anethole;

estragole;

eugenol;

cinnamaldehyde; and

menthol.

In one embodiment, the tooth powder is substantially free from artificial sweeteners.

As used herein, the term “artificial sweeteners” refers to compounds imparting sweetness not found naturally in nature or produced by organisms. In one embodiment, the artificial sweetener is aspartame. In one embodiment, the artificial sweetener is sucralose. In one embodiment, the artificial sweetener is glucin. In one embodiment, the artificial sweetener is xylitol. In one embodiment, the artificial sweetener is saccharin. In one embodiment, the artificial sweetener is acesulfame. In one embodiment, the artificial sweetener is neotame.

Disclosed herein is dental chew formulation comprising a tooth powder composition of:

nimbin;

nimbinin;

Nimbidin;

trans-anethole;

estragole;

eugenol;

cinnamaldehyde; and

menthol; and

Starch.

As used herein, the term “trans-anethole” refers to a compound with the following structural formula:

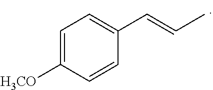

Trans-anethole is often characterized as a flavoring agent. In one embodiment, trans-anethole is derived from anise. In one embodiment, trans-anethole is derived from fennel. In one embodiment, trans-anethole is derived from basil.

As used herein, the term “eugenol” refers to a compound with the following structural formula:

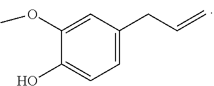

Eugenol is often characterized as an essential oil of cloves, nutmeg, cinnamon, basil, bay leaf, etc. In one embodiment, eugenol is derived from cloves. In one embodiment, eugenol is derived from basil.

As used herein, the term “cinnamaldehyde” refers to a compound with the following structural formula:

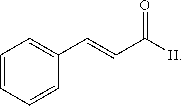

Cinnamaldehyde is often characterized as the active component in cinnamon. In one embodiment, cinnamaldehyde is derived from cinnamon.

As used herein, the term “menthol” refers to a compound with the following structural formula:

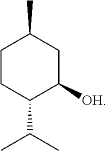

Menthol is often characterized as the main component of mint. In one embodiment, menthol is derived from mint.

As used herein, the term “estragole” refers to a compound with the following structural formula:

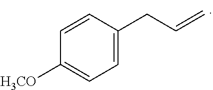

Estragole is often characterized as isomer of anethole. In one embodiment, estragole is derived from fennel. In one embodiment, estragole is derived from anise. In one embodiment, estragole is derived from basil. In one embodiment, estragole is derived from tarragon.

As used herein, the term “starch” refers to a carbohydrate consisting of a large number of glucose units joined by glycosidic bonds. As a food additive, starch is often used as a stabilizer and/or thickener. In one embodiment, starch is derived from plants. In one embodiment, starch is derived from potatoes. In one embodiment, starch is derived from corn. In one embodiment, starch is derived from rice.

### Example A

Step 1: Making dry base

A dry base was made by combining moong beans, lentils, oats, pumpkin seeds, flaxmeal, coconuts, and sunflower seed paste. These ingredients comprise were calculated to 96.7% of the total dry mass of the dry base.

Monocalcium phosphate, calcium carbonate, dried kelp, taurine, zinc oxide, ferrous sulfate, D1-alphatocopheryl acetate, choline chloride, selenium, Vitamin B12, Vitamin A palmitate, and ergocalciferol were calculated to 1.3% of the total dry mass of the dry base.

Step 2: Identifying a need

A dog in need of treatment was first identified. Through a series of evaluations, the dog's physique, energy level, diet, eating habits, and physical characteristics were determined. A computer program was used to determine the treatment of compositions. Then additional ingredients were chosen to treat the dog.

Vata Base

For the remaining 2% of the dry base, turmeric, fennel, ginger, ashwagandha, terminalia belerica, emblica officinalis, and terminalia chebula were combined with the above dry base. Pitta Base

For the remaining 2% of the dry base, neem, fennel, basil, turmeric, bacopa monnieri, terminalia belerica, emblica officinalis, and terminalia chebula were combined with the above dry base.

Kapha Base

For the remaining 2% of the dry base, turmeric, ginger, basil, fenugreek, shatavari, terminalia belerica, emblica officinalis, and terminalia chebula were combined with the above dry base.

These ingredients were thoroughly mixed together in a ribbon mixer to form a cohesive mass.

Step 3: Making wet base

A wet base was made by combining sprouted moong bean puree, sprouted yellow and green pea puree, and sprouted chickpea puree. These ingredients comprise 37.5% of the wet base.

The sprouted ingredients were sprouted for 3-5 days at 70 degrees fahrenheit. The sprouted ingredients were then soaked and rinsed. The sprouted ingredients were then steamed and pureed.

Based on the need of the mammal one of three possible compositions was made.

Vata Base

For the remainder 62.5%, sweet potatoes, carrots, beets, butternut squash, watercress, pumpkin, and spinach were combined with the wet base above.

Pitta

For the remainder 62.5%, kale, spinach, zucchini, butternut squash, pumpkin, cilantro, and carrots were combined with the wet base above.

Kapha

For the remainder 62.5%, broccoli, green beans, beets, butternut squash, kale, curry leaves, and carrots were combined with the wet base above.

The above bases were grinded individually to form a puree of each ingredient. Leafy green ingredients were steamed and cooled before pureed.

All ingredients were combined to create a wet base.

Step 4: Kneading

A mixture was made by combining one-part wet base with five parts dry base. The mixture was then placed in a mixer until a cohesive dough was made.

Step 5: Processing

The dough was placed into a roller creating bars. The bars were then placed into a sheeting machine to create sheets roughly 2 mm thick. The sheets were placed in an oven at 200 degrees fahrenheit for 10 minutes. The sheets were taken out and cut into squares and were placed back into the oven for 2 additional hours at 200 degrees fahrenheit. The squares were allowed to cool for about an hour before packing.

Step 6: Packaging

The squares made in step 4 were placed into foil lined packaging and vacuum sealed. Resulting in a package resistant to heat, sunlight, and air.

### Example B

Curry n Pepper (CNP) meals are prepared according to recipes as provided hereinbelow. Equipment for preparing said meals comprise the following:

Pressure Cooker/Large Utensils to cooks beans;

Commercial grinder & Food Processor to coarse grind beans & veggies;

Vacuum Sealer;

Freezer for freezing ice packs and food storage;

Large Utensils for soaking beans and draining the water out;

Spoons & Spatulas.

It should further be noted that it is preferred to wash all produce thoroughly prior to using it in the recipes. Water that meets the microbial standards for drinking water is considered “safe and sanitary.” The water used for cleaning the produce should not be re-used. Wash water guidelines may be found, for example, at https://www.fda.gov/downloads/Food/GuidanceRegulation/UCM169112.pdf.

Vata (Recipe 1, V):

Ingredients are provided as in the Table hereinbelow for Recipe 1, V; with percentages representing relative amounts of the various ingredients, whose actual amounts may be approximated according to the required instance per ordinary skill in the art:

| Ingredient | % |
|---|---|
| Chickpeas, cooked | 30.87849313 |
| Moong bean Lentil (Dal) cooked | 37.05419176 |
| Sunflower seeds meal | 6.793268488 |
| Quinoa, cooked | 4.940558901 |
| Shiitake mushrooms, cooked | 3.705419176 |
| Sweet potato, cooked, NO skin | 2.47027945 |
| Mung beans, sprouted | 2.47027945 |
| Asparagus, raw | 2.47027945 |
| Carrots, fresh | 2.47027945 |
| Zucchini, fresh | 2.47027945 |
| Beets, fresh | 1.235139725 |
| CNP Supplement | 0.864597808 |
| Sesame oil | 1.729195615 |
| Walnut oil | 0.247027945 |
| Taurine | 0.123513973 |
| Salt | 0.077196233 |

Steps for preparation include the following:

Step 1: Preparing Chickpeas:

For the quick soak method, add the beans to a large pot, cover with several inches of water and bring to a boil. Boil for 5 minutes then take the pot off of the heat (or turn off the stove) and let the beans sit in the water for 1 hour. After soaking the beans, drain and rinse them well. Add them to a large pot, cover the beans with several inches of water, and bring everything to a boil. Reduce the heat and simmer until they are fully cooked and tender (about 1½ to 2 hours) (Seed Volume doubles when cooked).

Step 2: Preparing moong bean lentil (dal):

Rinse the lentils 2-3 times and place them in a pot. Bring to the boil, skimming off any scum that forms. Cover and simmer for around 40 minutes, giving the pot an occasional stir (About 30-40 minutes) (Seed Volume doubles when cooked).

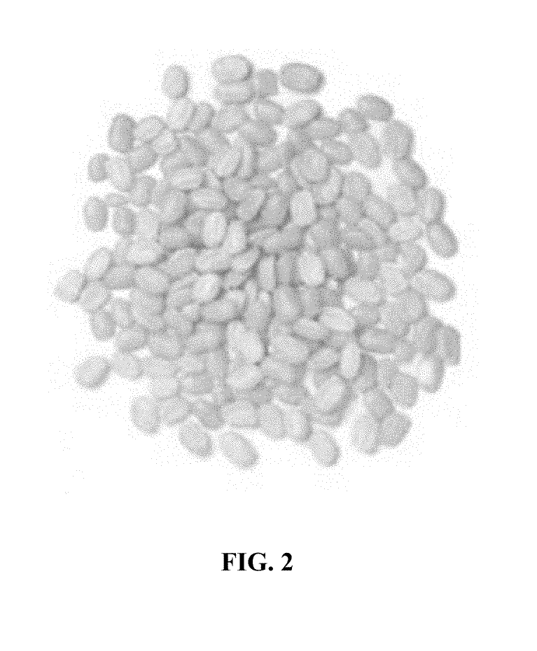

Mung bean lentils/dal (dehulled mung beans) are shown, by way of example, in FIG. 2.

Step 3: Preparing Quinoa: (Seed Volume Triples when cooked)

Measure 1 cup of quinoa and place into a fine-mesh strainer. Rinse thoroughly with cool water for about 2 minutes. Rub and swish the quinoa with your hand while rinsing. Drain the water. Bring 2 parts water to a boil and add 1-part quinoa, lower heat to medium and cook quinoa until fully cooked. (15-20 minutes).

Step 4: Prepare Mushroom:

Dice mushroom and steam them lightly. If using dehydrated mushroom, rehydrated per package instructions and chop them finely. (dehydrated mushroom may quadruple when hydrated);

Step 5: Wash, chop and Steam sweet potatoes without skin until tender;

Step 6: Cool and Coarsely grind Chickpeas;

Step 7: Add finely chopped/grated veggies/mushrooms, quinoa;

Step 8: Add sunflower seeds meal, supplement, Taurine, salt and mix all ingredients;

Step 9: Add cooked moong bean dal, cooked sweet potato, sesame oil and walnut oil, mix again and package;

Step 10: Package mung bean sprouts separately. Seven (7) oz pack.

Pitta (Recipe 2, P):

Ingredients are provided as in the Table hereinbelow for Recipe 2, P; with percentages representing relative amounts of the various ingredients, whose actual amounts may be approximated according to the required instance per ordinary skill in the art:

| Ingredients | % |
|---|---|
| Chickpeas, cooked | 30.58103976 |
| Black eyed peas, cooked | 23.54740061 |
| Moong bean dal, cooked | 15.29051988 |
| Sunflower seed meal | 8.409785933 |
| Salt | 0.114678899 |
| Sesame oil | 2.079510703 |
| Broccoli Riced Raw | 4.587155963 |
| Cauliflower Riced Raw | 4.587155963 |
| Bell pepper, green Raw | 4.587155963 |
| Zucchini Raw | 4.587155963 |
| Walnut oil | 0.305810398 |
| CNP Supplement | 1.070336391 |
| Taurine | 0.152905199 |
| B-complex 50 (Vitamin Shoppe) | 0.125 tablet/.5 cap |

Steps for preparation include the following:

Step 1: See Recipe V for detailed instructions on cooking chickpeas & mung bean lentil (dal);

Step 2: Preparing black eye peas: Follow same instructions as chickpeas, cooking time about 1-1.5 hrs.;

Step 3: Cool and Coarsely grind Chickpeas and black eye peas;

Step 4: Add finely chopped/grated veggies;

Step 5: Add sunflower seeds meal, supplement, Taurine, B-Complex, and turmeric and mix all ingredients;

Step 6: Add cooked moong bean lentil/dal, sesame oil and algae oil. Mix again and package;

Step 7: Include a pack of 7 oz mung bean sprouts.

Immediately after preparation the food optimally should be vacuum packed and refrigerated. The packaged food optimally should be shipped out within 3-4 hours of preparation.

Kapha (Recipe 3, K):

Ingredients are provided as in the Table hereinbelow for Recipe 3, K; with percentages representing relative amounts of the various ingredients, whose actual amounts may be approximated according to the required instance per ordinary skill in the art:

| Ingredients | % |
|---|---|
| Black beans, cooked | 34.83309144 |
| Red lentils Cooked | 21.77068215 |
| Buckwheat Groats, cooked (Barley was replaced | 17.41654572 |
| with Buckwheat) | |
| Sunflower seeds meal | 7.982583454 |
| Cabbage Raw | 4.35413643 |
| Spinach Raw | 4.35413643 |
| Green beans Raw | 3.628447025 |
| Carrots Raw (Celery was replaced with Carrots) | 3.628447025 |
| Walnut oil | 0.290275762 |
| Supplement ((to be provided by Curry n Pepper) | 1.015965167 |
| B-complex 50, Vitamin Shoppe | 1/16 tablet/0.25 cap |
| Zinc 30 mg (was added instead of Taurine) | 1 tablet (30 mg) |

Steps for preparation include the following:

Step 1: Preparing black beans: Follow same instructions as chickpeas. Cook time 1 hr to 1.5 hrs;

Step 2: Preparing red lentils: Rinse the lentils 2-3 times and then follow same cooking process as mung bean lentils. (30-40 minutes);

Step 3: Preparing Buckwheat: Combine 1-part buckwheat groats with 1¾ parts water, Bring to a simmer then cover with a tight fitting lid and simmer on low for 18-20 minutes. Just like with rice, you should hear hissing while it's cooking, and it will get quiet when it's done;

Step 4: Cool and Coarsely grind beans;

Step 5: Add finely chopped/grated veggies and buckwheat;

Step 6: Add sunflower seeds meal, supplement, Taurine, B-Complex, and mix all ingredients;

Step 7: Add cooked red lentils, and algae oil. Mix again and package;

Step 8: Include a pack of 7 oz mung bean sprouts.

It should be noted that B50-Complex and Zinc is understood to be in cap form and the amount/dosage listed in the recipe above is per 550 g of finished product.

It should further be noted that long lasting ice packs for shipping may be used for optimal performance including by way of example Nordic pack available at https://nordicice.com) or Black Ice available at http://coldchain.polar-tech.com/.

### Example C

The following compositions within the ambit of the present invention may be produced as provided in the following Tables hereinbelow giving the ingredient common name, species identification, and percent in formula; as well as function information:

TABLE 1
VATA FORMULA

| INGREDIENT | | PERCENT | |
|---|---|---|---|
| COMMON | SPECIES | IN | |
| NAME | IDENTIFICATION | FORMULA | FUNCTION |
| Haritaki fruit | Terminalia chebula | 25 | Studies indicate antiviral, antiyeast, |
| | | | antihistaminic, anti-inflammatory, |
| | | | laxative, and antibacterial activities for |
| | | | this herb. Antibacterial activity |
| | | | includes effectiveness against E. coli, |
| | | | Salmonella typhosa, Salmonella |
| | | | paratyphosa A, B, and C, Cholera, |
| | | | Shigella, Klebsiella, and Pseudomonas. |
| Amalaki (Indian | Emblica officinalis | 15 | Adaptogenic herb; indicated for |
| gooseberry) fruit | | | anemia, asthma, bleeding gums, |
| | | | diabetes, colds, chronic lung disease, |
| | | | hyperlipidemia, hypertension, yeast |
| | | | infections, and neoplastic conditions; |
| | | | source of bioflavonoids and vitamin C |
| Bibhitaki fruit | Terminalia belerica | 15 | Beneficial for asthma and chronic |
| | | | sinusitis; antihistaminic, antitussive, |
| | | | antibacterial, antifungal, and antiyeast. |
| | | | Astringent, hemostatic agent, |
| | | | expectorant, and laxative. Commonly |
| | | | used in dysentery, bronchitis, and |
| | | | hepatitis |
| Ashwaganda | Withania somnifera | 15 | Similar to ginseng, has rejuvenating |
| | | | qualities; adaptogen, promotes health |
| | | | and longevity. Enhances immune |
| | | | function and blood production; used |
| | | | for inflammation, bacterial infection, |
| | | | and diarrhea. Soothing to the nervous |
| | | | system. |
| Sesame seed | Sesamum indicum | 10 | Chronic cought, ‘weak lungs’, chronic |
| | | | constipation, gingivitis, hair loss |
| Fenugreek | Trigonella foenum- | 10 | Improves digestive function (soluble |
| | graecum | | fiber content). Also used for chronic |
| | | | coughs and bronchitis |
| Ginger | Zingiber officinale | 5 | Expectorant, carminative, antiemetic, |
| | | | analgesic, and anti-inflammatory by |
| | | | inhibiting enzymes of both the |
| | | | lipoxygenase and cyclooxygenase |
| | | | pathways. Used for colds, fever, |
| | | | nausea, motion sickness, vomiting, |
| | | | eructation, abdominal discomfort, |
| | | | headaches, heart disease, laryngitis, |
| | | | and arthritis. |
| Turmeric | Curcuma longa | 5 | Anti-inflammatory, hepatoprotective |
| | | | and functions as a choleretic and |
| | | | cholegogue. Antioxidant and |
| | | | antimicrobial. |

TABLE 2
PITTA FORMULA

| INGREDIENT | | PERCENT | |
|---|---|---|---|
| COMMON | SPECIES | IN | |
| NAME | IDENTIFICATION | FORMULA | FUNCTION |
| Amalaki (Indian | Emblica officinalis | 25 | Adaptogenic herb; indicated for |
| gooseberry) fruit | | | anemia, asthma, bleeding gums, |
| | | | diabetes, colds, chronic lung disease, |
| | | | hyperlipidemia, hypertension, yeast |
| | | | infections, and neoplastic conditions; |
| | | | source of bioflavonoids and vitamin C |
| Bibhitaki fruit | Terminalia belerica | 15 | Beneficial for asthma and chronic |
| | | | sinusitis; antihistaminic, antitussive, |
| | | | antibacterial, antifungal, and antiyeast. |
| | | | Astringent, hemostatic agent, |
| | | | expectorant, and laxative. Commonly |
| | | | used in dysentery, bronchitis, and |
| | | | hepatitis |
| Haritaki fruit | Terminalia chebula | 15 | Studies indicate antiviral, antiyeast, |
| | | | antihistaminic, anti-inflammatory, |
| | | | laxative, and antibacterial activities for |
| | | | this herb. Antibacterial activity |
| | | | includes effectiveness against E. coli, |
| | | | Salmonella typhosa, Salmonella |
| | | | paratyphosa A, B, and C, Cholera, |
| | | | Shigella, Klebsiella, and Pseudomonas. |
| Gotu cola | Centella asiatica | 10 | Improves circulation, especially in |
| (Brahmi) | | | nervous tissue; used as a nervine and |
| | | | brain tonic; improves memory. Anti- |
| | | | inflammatory and diuretic. |
| Shatavari | Asparagus | 10 | Root is demulcent, diuretic, |
| | racemosus root | | aphrodisiac, tonic, alterative, |
| | | | antiseptic, and antidiarrheal properties. |
| | | | Used to treat debility, infertility, |
| | | | stomach ulcers, hyperacidity, |
| | | | dehydration, lung abscesses, |
| | | | hematemesis, cough, and chronic |
| | | | fevers |
| Boswellia (Salai) | Boswellia serrata | 10 | Used primarily for pain and |
| | | | inflammation, rheumatism, dysentery |
| | | | and diarrhea, and inflammatory skin |
| | | | disease. Has anti-inflammatory, |
| | | | expectorant, and diuretic properties. |
| | | | Studies confirm its value for ulcerative |
| | | | colitis and Crohn's disease. Also |
| | | | effective for inflammatory skin |
| | | | diseases such as psoriasis and for |
| | | | bronchial asthma. |
| Nutmeg | Myristica fragrans | 5 | For abdominal discomfort, diarrhea, |
| (Jaiphala) | | | and intestinal gas. Also used for |
| | | | insomnia and anxiety. Improves |
| | | | intestinal absorption of nutrients. |
| | | | Considered to be beneficial for patients |
| | | | with inflammatory bowel disease. |
| Mint | Mentha spp | 5 | Addresses respiratory, digestive, |
| | | | nervous, and cardiovascular conditions. |
| | | | Uses include colds, fever, sore throat, |
| | | | laryngitis, headache, dyspepsia, |
| | | | nervousness, and agitation. |
| Licorice | Glycyrrhiza glabra | 5 | Used for cough, cold, bronchitis, sore |
| (Yashtimadhu) | | | throat, laryngitis, stomach ulcers, |
| | | | gastric hyperacidity, and painful |
| | | | urination |

TABLE 3
KAPHA FORMULA

| INGREDIENT | | PERCENT | |
|---|---|---|---|
| COMMON | SPECIES | IN | |
| NAME | IDENTIFICATION | FORMULA | FUNCTION |
| Bibhitaki fruit | Terminalia belerica | 25 | Beneficial for asthma and chronic |
| | | | sinusitis; antihistaminic, antitussive, |
| | | | antibacterial, antifungal, and antiyeast. |
| | | | Astringent, hemostatic agent, |
| | | | expectorant, and laxative. Commonly |
| | | | used in dysentery, bronchitis, and |
| | | | hepatitis |
| Amalaki (Indian | Emblica officinalis | 15 | Adaptogenic herb; indicated for |
| gooseberry) fruit | | | anemia, asthma, bleeding gums, |
| | | | diabetes, colds, chronic lung disease, |
| | | | hyperlipidemia, hypertension, yeast |
| | | | infections,and neoplastic conditions; |
| | | | source of bioflavonoids and vitamin C |
| Haritaki fruit | Terminalia chebula | 15 | Studies indicate antiviral, antiyeast, |
| | | | antihistaminic, anti-inflammatory, |
| | | | laxative, and antibacterial activities for |
| | | | this herb. Antibacterial activity |
| | | | includes effectiveness against E. coli, |
| | | | Salmonella typhosa, Salmonella |
| | | | paratyphosa A, B, and C, Cholera, |
| | | | Shigella, Klebsiella, and Pseudomonas. |
| Fennel seed | Foeniculum vulgare | 15 | Used for abdominal discomfort, |
| (Saumph) | | | dyspepsia, bloating, and colic; has also |
| | | | been used for cystitis and increasing |
| | | | milk production. |
| Guggul | Commiphora mukul | 10 | Addresses lipid metabolism, thyroid |
| | | | metabolism, and benefits digestive |
| | | | function. Traditional applications |
| | | | include rheumatoid arthritis, obesity, |
| | | | dermatologic conditions, and lower |
| | | | urinary tract disorders. Extensively |
| | | | studied with respect to its |
| | | | hypolipidemic, cholesterol-lowering |
| | | | and antiatherosclerotic activities. These |
| | | | studies have determined that guggal's |
| | | | impact on lipid metabolism results |
| | | | from the thyroid-stimulating activity of |
| | | | a ketosteroid - guggulsterone - found |
| | | | in this resinous extract |
| Cardamom | Elettaria | 5 | Colds, cough, bronchitis, asthma; |
| | cardamomum | | improves intestinal absorption. |
| | | | Antiemetic, reduces belching when |
| | | | combined with fennel. Improves spleen |
| | | | function, scours phlegm from lungs and |
| | | | gastrointestinal tract, addresses Kapha |
| | | | pathology. |
| Cinnamon bark | Cinnamomum cassia | 5 | Improves circulation, digestive |
| (Dalchini) | or C. zeylanicum | | function, and respiratory function. |
| | | | Traditionally used for colds, sinus |
| | | | congestion, bronchitis, and dyspepsia. |
| | | | More recent studies show that |
| | | | cinnamon may be effective in |
| | | | controlling high blood glucose |
| | | | associated with Type 2 diabetes. |
| Asafoetida | Ferula foetida | 5 | Used for indigestion, flatulence, |
| | | | abdominal distention, colic, |
| | | | constipation, arthritis, and epilepsy. |
| Black pepper | Piper nigrum | 5 | Improves digestion and circulation; |
| (Marichi) | | | addresses obesity, sinus congestion. |

Although the present invention herein has been described with reference to various exemplary embodiments, it is to be understood that these embodiments are merely illustrative of the principles and applications of the present invention. Those having skill in the art would recognize that various modifications to the exemplary embodiments may be made, without departing from the scope of the invention.

Moreover, it should be understood that various features and/or characteristics of differing embodiments herein may be combined with one another. Various isomeric forms, salts, functional derivatives, esters, ethers, etc., of compounds will be understood to be within the scope of this disclosure. As well as any stereoisomeric forms as well. It is therefore to be understood that numerous modifications may be made to the illustrative embodiments and that other arrangements may be devised without departing from the scope of the invention.

Furthermore, other embodiments of the invention will be apparent to those skilled in the art from consideration of the specification and practice of the invention disclosed herein. It is intended that the specification and examples be considered as exemplary only, with a scope and spirit being indicated by the claims.

Finally, it is noted that, as used in this specification and the appended claims, the singular forms “a,” “an,” and “the,” include plural referents unless expressly and unequivocally limited to one referent, and vice versa. As used herein, the term “include” or “comprising” and its grammatical variants are intended to be non-limiting, such that recitation of an item or items is not to the exclusion of other like items that can be substituted or added to the recited item(s).

What is claimed is:

1. A food composition, comprising:
linoleic acid;
palmitic acid;
p-coumaric acid;
oleic acid;
caffeic acid;
pantothenic acid;
an antioxidant;
a probiotic; and
an ellagitannin.

2. The food composition of claim 1, wherein the antioxidant is chosen from Vitamin E, Vitamin C, Vitamin B1, or Vitamin B6.

3. The food composition of claim 1, wherein the ellagitannin is chosen from chebulinic acid, chebulic acid, luteic acid, chebulagic acid, emblicanin A, emblicanin B, punigluconin, or pedunculagin.

4. The food composition of claim 1, comprising a steroidal lactone chosen from tropine, cuscohygrine, or a withanolide.

5. The food composition of claim 1, comprising a bacoside.

6. The food composition of claim 1, comprising trigonelline, cinnamic acid, or scopoletin.

7. The food composition of claim 1, comprising nimbin, nimbinin, or nimbidin.

8. A method for making a food composition, comprising:
creating a dry base;
pureeing sprouted ingredients and dosha based vegetables into a wet base;
kneading the dry base and the wet base into a dough;
cutting the dough into bars;
flattening the bars into sheets;
heating the sheets; and
cutting the sheets into squares.

9. The method of claim 8, comprising placing the squares into packaging resisting sunlight, temperatures, and air.

10. The method of claim 8, comprising total dry mass of the squares is equal to total dry mass of the dry base.

11. The method of claim 8, wherein the water content of the squares is less than 10%.

12. The method of claim 8, comprising vacuum sealing the squares into a bag.

13. A method of treating a mammal comprising:
identifying a mammal in need of treatment; and
administering to said mammal a composition comprising,
linoleic acid;
palmitic acid;
p-coumaric acid;
oleic acid;
caffeic acid;
pantothenic acid;
an antioxidant;
a probiotic; and
an ellagitannin.

14. The method of claim 13, wherein the antioxidant is chosen from Vitamin E, Vitamin C, Vitamin B1, Vitamin B5, or Vitamin B6.

15. The method of claim 13, wherein the ellagitannin is chosen from chebulinic acid, chebulic acid, luteic acid, chebulagic acid, emblicanin A, emblicanin B, punigluconin, or pedunculagin.

16. The method of claim 13, comprising a steroidal lactone chosen from tropine, cuscohygrine, or a withanolide.

17. The method of claim 13, comprising a bacoside.

18. The method of claim 13, comprising trigonelline, cinnamic acid, or scopoletin.

19. The method of claim 13, comprising nimbin, nimbinin, or nimbidin.

20. The method of claim 13, comprising treating teeth or gums.

21. A tooth powder composition, comprising:
nimbin;
nimbinin;
nimbidin;
trans-anethole;
estragole;
eugenol;
cinnamaldehyde; and
menthol.

22. The tooth powder of claim 21, comprising substantially free from artificial sweeteners.

23. A dental chew formulation comprising, the composition of claim 21 and starch.
